(19) United States
(12) Patent Application Publication
(10) Pub. No.: US 2011/0297897 A1
(43) Pub. Date: Dec. 8, 2011

(54) PROCESS FOR PRODUCING WATER-PROOF POLARIZING FILM

(75) Inventors: Toru Umemoto, Osaka (JP); Satoru Suzuki, Osaka (JP); Tadayuki Kameyama, Osaka (JP)

(73) Assignee: NITTO DENKO CORPORATION, Ibaraki-shi, Osaka (JP)

(21) Appl. No.: 13/202,494

(22) PCT Filed: Oct. 5, 2009
(86) PCT No.: PCT/JP2009/005139

§ 371 Date: Aug. 19, 2011

(30) Foreign Application Priority Data
Feb. 26, 2009 (JP) 2009-043289

(51) Int. Cl. G02B 5/30

(52) U.S. Cl. 252/585

(57) ABSTRACT

There is provided, a process for producing a water-proof polarizing film having a high dichroic ratio free from cracks by contacting a polarizing film including a mixture of an organic dye and polyvinyl alcohol-based polymers with a water-proof treatment liquid containing the following to perform water-proof treatment:
(1) at least one of organic amine cations and multivalent metal cations; and
(2) tetrahydroxy borate anions.

### BACKGROUND OF THE INVENTION

1. Field of the Invention

The present invention relates to a process for producing a water-proof polarizing film.

2. Description of Related Art

Conventionally, a polarizing film using an organic dye having a sulfonate group in which a sulfonic ion and a monovalent, cation are bonded to each other is known. However, such a polarizing film is poor in water resistance because the organic dye is dissolved in water. Thus, a process for obtaining a water-proof polarizing film which is insoluble or hardly solves in water by substituting a monovalent cation of the aforementioned sulfonate group for a multivalent cation insoluble in water (for instance, Japanese Patent Application Laid-on Publication No. 11-21538 A).

However, water roof polarizing films obtained by conventional method have a problem that the water-proof polarizing films respectively have a small dichroic ratio and fine cracks are generated on a surface thereof.

### SUMMARY OF THE INVENTION

It is an object of the present invention to provide a process for producing a water-proof polarizing film having a dichoric ratio greater than conventional ones free from cracks.

The inventors of the present invention have found out that it is possible to obtain a water-proof polarizing film having a high dichroic ratio free from cracks by contacting a polarizing film including a mixture of an organic dye and polyvinyl alcohol-based polymers with a water-proof treatment liquid containing the following to perform water-proof treatment:

(1) at least one of organic amine cations and multivalent metal cations; and

(2) tetrahydroxy borate anions.

The tetrahydroxy borate anion is a boric acid or a borate derived anion. Effects thereof will now be described below.

### (a) Effects of Polyvinyl Alcohol-Based Polymer

An addition of a small amount of polyvinyl alcohol-based polymers to an organic dye results in effects of inhibiting aggregation and crystallization of the organic dye. The terms “a small amount of” herein mean 20% by weight or smaller relative to the total weight of a polarizing film. Detailed mechanism of these effects have not been clarified yet. While it is difficult to unidirectionally align orientation directions of organic dye molecules when there are aggregates and crystals in the polarizing film, it is possible to unidirectionally align, the orientation directions of the organic dye molecules when there are neither aggregates nor crystals in the polarizing film. As a result, the orientation degree of the organic dye molecules becomes high, which leads to obtain a polarizing film haying a high dichroic ratio.

### (b) Effects of Organic Amine Cation and Multivalent Metal Cation

Organic amine cations are generated by dissolving an organic amine hydrochloride in water and multivalent metal cations are generated by dissolving a multivalent metal salt in water. The organic amine cations and the multivalent metal cations are boned to anionic groups of organic dyes to make the organic dyes insoluble or poor in solubility.

### (c) Effects of Tetrahydroxy Borate Anion

Tetrahyroxy borate anions are generated by dissolving boric acid in water as described in the following formula:

H₃BO₃+H₂O←→H⁺+B(OH)₄—

As shown in the following formula (1), the generated tetrahydroxy borate anions are cross-linked by a hydrogen bond with a hydroxyl group of polyvinyl alcohol (a bond of the dotted line in the formula (1)) to allow the polyvinyl alcohol to be insoluble or poor in solubility. Further, the hydroxyl group of the polyvinyl alcohol is presumed to be hydrogen bonded to the organic dye.

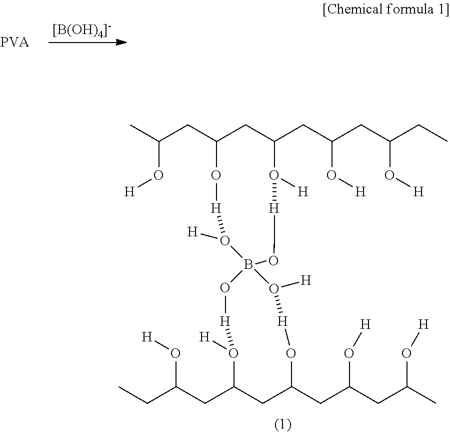

### (d) Synergetic Interaction of Tetrahydroxy Borate Anion/Organic Amine Cation and Multivalent Metal, Cation

Organic amine cations and multivalent metal cations selectively cross-link an organic dye in the polarizing film. And tetrahydroxy borate anions selectively cross-link polyvinyl alcohol-based polymers in the polarizing film. As a result, there is no possibility of any components of the organic dye and the polyvinyl alcohol-based polymers eluting when using a water-proof treatment liquid containing (1) at least one of organic amine cations and multivalent metal cations and (2) tetrahydroxy borate anions, even if the polarizing film is exposed to a humid environment. Accordingly, a water-proof polarizing film free from cracks is obtained while a high dichroic ratio is maintained.

The summary of the present invention is described as follows:

In a first preferred embodiment, a process for producing a water-proof polarizing film according to the present invention includes a step of performing water-proof treatment by contacting a water-proof treatment liquid containing at least one of organic amine cations and multivalent metal cations and tetrahydroxy borate anions with a surface of a polarizing film including an organic dye having at least two anionic groups and polyvinyl alcohol-based polymers.

In a second preferred embodiment of the process for producing a water-proof polarizing film according to the present invention, each of the anionic groups is any one of a sulfonic acid group, a carboxyl group, a phosphate group, and a base thereof.

In a third preferred embodiment of the process for producing a water-proof polarizing film according to the present invention, the organic dye is an azo compound represented by the following general formula (2)

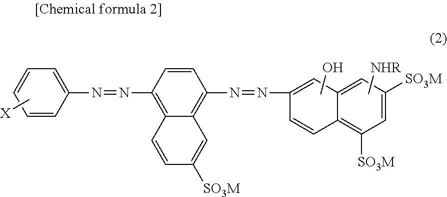

In the general formula (2), R is a hydrogen atom, an alkyl group having 1 to 3 carbon numbers, an acetyl group), a substituted or unsubstituted benzoyl group, or a substituted or unsubstituted phenyl group; X is a hydrogen atom, a halogen atom, a nitro group, a cyano group, an alkyl group having 1 to 4 carbon numbers, an alxoky group having 1 to 4 carbon numbers or a —SO₃M group. M is a hydrogen atom or an alkaline metal atom.

In a fourth preferred embodiment of the process for producing a water-proof polarizing film according to the present invention, a total concentration of the organic amine cations and the multivalent metal cations contained in the water-proof treatment liquid is 10% by weight to 25% by weight relative to the total weight of the water-proof treatment liquid and the tetrahydroxy borate anions have a concentration of 1% by weight to 6% by weight relative to the total weight of the water-proof treatment liquid.

In a fifth preferred embodiment of the process for producing a water-proof polarizing film according to the present invention, the water-proof treatment liquid has a liquid temperature of 5° C. to 60° C.

### ADVANTAGES OF THE INVENTION

According to the present invention, it is possible to obtain a water-proof polarizing film haying a high dichroic ratio and free from cracks.

### DESCRIPTION OF THE PREFERRED EMBODIMENTS

### [Process for Producing Water-Proof Polarizing Film]

A process for producing a water-proof polarizing film of the present invention includes a step of performing water-proof treatment by contacting a water-proof treatment liquid containing (1) at least one of organic amine cations and multivalent metal cations and (2) tetrahydroxy borate anions with a surface of a polarizing film including an organic dye having at least two anionic groups and polyvinyl alcohol-based polymers. This step is referred to as a water-proof treatment step.

The process for producing a water-proof polarizing film of the present invention may include other steps as long as these steps satisfy the aforementioned features. Examples of the other steps typically include a step of washing the adhered water-proof treatment liquid in water after water-proof treatment or a step of drying the polarizing film.

### [Polarizing Film Before Water-Proof Treatment]

The polarizing film before water-proof treatment to be used in the present invention includes an organic dye having at least two anionic groups and polyvinyl alcohol-based polymers. It is possible to obtain such a polarizing film by casting a coating liquid including the aforementioned organic dye, polyvinyl alcohol-based polymers, and a solvent and then orienting the organic dye.

The content of the organic dye included in the polarizing film before water-proof treatment is preferably 80% by weight or higher and less than 100% by weight. The content of the polyvinyl alcohol-based polymers is preferably over 0% by weight to 20% by weight or lower relative to the total weight of the polarizing film, more preferably over 0% by weight to 10% by weight or lower. The aforementioned polarizing film may include any additives or other organic dyes. Examples of such an additive include a surfactant, an antioxidant, an antistatic agent, an ultraviolet absorber, and an antibacterial agent or the like.

### [Organic Dye]

The organic dye to be used in the present invention has at least two anionic groups in a molecule structure. Examples of the aforementioned anionic group include a sulfonic acid group, a carboxyl group, a phosphate group, and a base thereof or the like. The number (substituted number) of anionic groups contained in the organic dye is preferably 2 to 4.

In such an organic dye, the anionic group acts as a substituent group to provide solubility in a hydrophilic solvent before contacting a water-proof treatment liquid (before water-proof treatment), so that it is easy to prepare a coating liquid.

On the other hand, the anionic group acts as a cross-linking point with the organic amine cations and multivalent metal cations after conducting water-proof treatment by contacting the water-proof treatment liquid with the organic dye, which leads to exhibit superior waterproofness. This makes it possible to obtain a water-proof polarizing film having significantly high waterproofness.

An organic dye described in Japanese Patent Application Laid-Open Publication Nos. JP 2007-126628 A and JP 2006-323377 A or the like may be used as the aforementioned organic dye. Such an organic dye listed in these publications exhibits liquid crystallinity (lyotropic liquid crystallinity) in a solution state and the organic dye may be oriented by flow when applying shearing force to the organic dye in a liquid crystal state. The aforementioned organic dye forms supramolecular aggregates in a solution. And a longitudinal direction of the supramolecular aggregates is oriented in a flow direction when applying shearing force to the solution containing these supramolecular aggregates.

The aforementioned organic dye is preferably an azo compound represented by the general formula (2) mentioned below. Such an azo compound exhibits stable liquid crystal phases (lyotropic liquid crystallin in a state of being dissolved in a solvent and is superior in orientation.

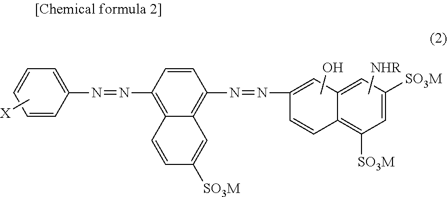

In the general formula (2), R is a hydrogen atom, an alkyl group having 1 to 3 carbon numbers, an acetyl group, a substituted or unsubstituted benzoyl group, or a substituted or unsubstituted phenyl group. X is a hydrogen atom, a halogen atom, a nitro group, a cyano group, an alkyl group having 1 to 4 carbon numbers, an alkoxy group having 1 to 4 carbon numbers or a —SO₃M group. M is a counterion and a hydrogen atom or an alkali metal atom.

It is possible to obtain the azo compound represented by the aforementioned general formula (2) by diazotizing and coupling an aniline derivative and a naphthalene sulfonate derivative in accordance with a conventional method and the obtained monoazo compound is subject to diazotization and coupling reaction with an amino naphthol disulfonic acid derivative.

### [Polyvinyl Alcohol-Based Polymer]

Any polyvinyl alcohol-based polymers may be used as the polyvinyl alcohol-based polymers in the present invention. The aforementioned polyvinyl alcohol-based polymer to be used in the present invention may be a straight-chain polymer or a branched polymer. Alternatively, the polyvinyl alcohol-based polymer may be a homopolymer or a copolymer composed of unit polymers of two kinds or more.

A typical example of a homopolymer is polyvinyl alcohol and a typical example of a copolymer is an ethylene vinyl alcohol copolymer.

The mean molecular weight (Mw) of the aforementioned polyvinyl alcohol-based polymer is not particularly limited, but is preferably 1,000 to 500,000.

The aforementioned polyvinyl alcohol-based polymer is preferably polyvinyl alcohol. Typically, polyvinyl alcohol is obtained by saponifying a polyvinyl acetate resin. The saponification degree of the polyvinyl alcohol is preferably 85 mole % to 100 mole %.

### [Water-Proof Treatment]

The water-proof treatment to be used in the present invention includes a step of contacting a water-proof treatment liquid containing (1) at least one of organic amine cations and multivalent metal cations and (2) tetrahydroxy borate anions with a surface of the polarizing film.

It is possible to obtain the aforementioned tetrahydroxy borate anions by dissolving boric acid or borate in water. Examples of the at aforementioned borate typically include lithium metaborate and sodium tetraborate or the like.

The aforementioned organic amine cations are preferably alkyldiamine cations having 1 to 6 carbon numbers, such as 1,4-butane diamine cations and 1,6-hexane diamine cations. It is possible to obtain organic amine cations by dissolving organic amine hydrochloride in water.

It is possible to obtain the aforementioned multivalent metal cations by dissolving multivalent metal salt in water. In addition, cations to coexist with tetrahydroxy borate anions may be either the organic amine cations or the multivalent metal cations or both of them.

The concentration of tetrahydroxy borate anions contained in the water-proof treatment liquid is preferably 1% by weight to 6% by weight relative to the total weight of the water-proof treatment liquid.

The concentration (the total concentration in the case where both are contained) of the organic amine cations and the multivalent metal cations contained in the water-proof treatment liquid is preferably 10% by weight to 25% by weight relative to the total weight of the water-proof treatment liquid.

When the concentration of the tetrahydroxy borate anions, the organic amine cations, and the multivalent metal cations is too high, there is a case that an excessive melt which is not incorporated into the polarizing film may precipitate on a surface of the water-proof polarizing film. Alternatively, there is a case where the effects of waterproofness may be smaller when such concentration is too low.

The liquid temperature of the water-proof treatment liquid is preferably 0.5° C. to 60° C. There is a possibility that the water-proof polarizing film may become cloudy when the liquid temperature is too high or low.

The water-proof treatment liquid is preferably a water solution containing boric acid and barium chloride. There are no fears of the water solution of boric acid and an barium chloride corroding an application coater because of being neutral or mildly acidic. Moreover, the water solution is easily available industrially.

Means (contacting means) for contacting the water-proof treatment liquid with a surface of the polarizing film is not particularly limited. The polarizing film may be immersed in a water-proof treatment liquid or the water-proof treatment liquid may be coated with a surface of the polarizing film.

### [Water-Proof Polarizing Film]

It is possible to obtain a water-proof polarizing film by subjecting the polarizing film to the aforementioned water-proof treatment in the present invention. In the case where the water-proof polarizing film includes an azo compound represented by the aforementioned general formula (2), the counterion in the formula are partially or wholly organic amine cations or multivalent metal cations.

The water-proof polarizing film obtained by the present invention exhibits absorption dichroism at least at one wavelength in a visible light region (at a wavelength of 380 nm to 780 nm). The thickness of the water-proof polarizing film obtained by the present invention is preferably 0.1 μm to 5 μm. The dichroic ratio of the water-proof polarizing film obtained by the present invention is preferably 20 or more.

### EXAMPLES

### Example 1

In accordance with a conventional method (“Riron Seizo Senryo Kagaku” Fifth Edition (Theoretical production Dye Chemistry), Yutaka Hosoda (published on Jul. 15, 1968, GIHODO SHUPPAN Co., Ltd.), pages 135 to 152), a monoazo compound was produced by diazotizing and coupling 4-nitroaniline and 8-amino-2-naphthalene sulfonic acid. The obtained monoazo compound was diazotized by a conventional method in the same manner and was further subject to diazotization and coupling reaction with 1-amino-8 naphthol-2,4-disulfonate lithium salt to obtain a rough product including an azo compound having the following structural formula (3) and salting out was carried out with lithium chloride to obtain an azo compound having the following structural formula (3):

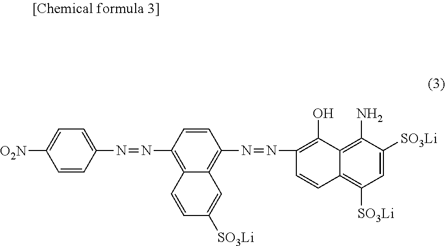

A coating liquid having an azo compound concentration of 20% by weight was prepared by dissolving 100 weight parts of the azo compound of the aforementioned structural formula (3) and 0.5 weight parts of polyvinyl alcohol (produced by KURRAY CO., LTD., product name: “PVA-117”, mean molecular weight: 75,000) in ion-exchange water. This coating liquid exhibited nematic liquid crystal phases.

The coating liquid was coated with a surface of an olefln-based resin film (produced by Nippon Zeon Co., Ltd., product name: “Zeonor”) with rubbing treatment using a bar coater (produced by BUSCHMAN, product name: “Mayerrot HS4”) to obtain a polarizing film (before water-proof treatment) having a width of 0.4 μm by natural drying in a temperature-controlled room at 23° C.

Next, the polarizing film was immersed in 10% by weight of 1,4-butane diamine hydrochloride (produced by Tokyo Kasei K. K.) and 3% by weight of boric acid (produced by WAKO Chemical Ltd.) for 1 minute to conduct water-proof treatment and after washing with water, the polarizing film was naturally dried in a constant temperature room at 23° C. to produce a water-proof polarizing film. Table 1 shows characteristics of the obtained water-proof polarizing film. Even when the water-proof polarizing film was allowed, to stand for 500 hours in a constant temperature and constant humidity roam at 60° C. and 90% RH, the change of dichoric ratio is less than 1% and turned out to be superior in durability.

### Example 2

A water-proof polarizing film was obtained, in the same manner as in Example 1 except for using barium chloride (produced by Tokyo Kasei K.K.) as a substitute for 1,4-butan diamine hydrochloride Table 1 shows characteristics of the obtained water-proof polarizing film.

### Comparative Example 1

A water-proof polarizing film was obtained in the same manner as in Example 1 except for not using boric acid. Table 1 shows characteristics of the obtained water-proof polarizing film.

### Comparative Example 2

A polarizing film was obtained in the same manner as in Example 1 except for not using 1,4-butane diamine hydrochloride. Table 1 shows characteristics of the obtained polarizing film.

### Comparative Example 3

A polarizing film was obtained in the some manner as in Example 1 except for not using polyvinyl alcohol. Table 1 shows characteristics of the obtained polarizing film.

TABLE 1

| | | Cations and anions contained in | | Characteristics of a waterproof polarizing film | | |
|---|---|---|---|---|---|---|
| | Polyvinyl | a waterproof treatment liquid | | Water | | |
| | alcohol | Cations | Anions | proofness | Dichroic ratio | Cracks |
| Example 1 | Contained | 1,4-butane | Tetrahydroxy | ∘ | 27 | Invisible |
| | | diamine cations | borate anions | | | |
| Example 2 | Contained | Barium cations | Tetrahydroxy | ∘ | 26 | Invisible |
| | | | borate anions | | | |
| Comparative | Contained | 1,4-butane | Nil | ∘ | 19 | Visible |
| Example 1 | | diamine cations | | | | |
| Comparative | Contained | Nil | Tetrahydroxy | x | Unmeasurable | Unmeasurable |
| Example 2 | | | borate anions | | (Dissolution of | (Dissolution of |
| | | | | | polarizing film) | polarizing film) |
| Comparative | Not | 1,4-butane | Tetrahydroxy | ∘ | 15 | Visible |
| Example 3 | contained | diamine cations | borate anions | | | |

### [Measurement Method]

### [Measurement of Thickness]

A portion of a polarizing film was released to obtain the thickness of the polarizing film by measuring the level difference using a three-dimensional measurement system of the shape of a non-contact surface (manufactured by Ryoka Systems, Inc., product name: Micromap “MM5200”).

### [Observation of Liquid Crystal Phase]

A plurality of samples of water solutions for respective concentrations were prepared and a small amount of respective water solutions was sandwiched by two pieces of slide glasses to observe a liquid crystal phase using a polarization microscope (manufactured by Olympus, product name: “OPTIPHOT-POL”).

### [Evaluation of Waterproofness]

A visual observation was conducted as to whether a sample of the polarizing film was maintained or dissolved when the sample of the polarizing film was immersed in a water-proof treatment liquid.

### [Evaluation of Dichroic Ratio]

Measuring light of linear polarization was allowed to enter using a spectrophotometer with Glan-Thompson polarizer (produced by JASCO Corporation, product name: U-4100). And k₁ and k₂ of value whose visibility had been corrected were obtained to calculate the dichroic ratio from the following equation:

Dichroic ratio=log(1/k₂)/log(1/k₁)

wherein k₁ is a transmittance of a linear polarization in a maximum transmittance direction and k₂ is a transmittance of a linear polarization in a direction that is perpendicular to the maximum transmittance direction.

### [Evaluation of Cracks]

It was observed whether or not there are any cracks on the water-proof polarizing film using a polarization microscope (manufactured by Olympus, product name: “OPTIPHOT-POL”) at 100-fold magnification.

### INDUSTRIAL APPLICABILITY

The water-proof polarizing film obtained, by the present invention, is preferably used for liquid crystal panels, such as liquid crystal television units, liquid crystal displays, cell phones, digital cameras, video cameras, portable game devices, car navigation system, coping machines, printers, facsimile machines, watches, and microwave ovens or the like.

What is claimed is:

1. A process for producing a water-proof polarizing film comprising a step of performing water-proof treatment by contacting a water-proof treatment liquid containing at least one of organic amine cations and multivalent metal cations and tetrahydroxy borate anions with a surface of a polarizing film including an organic dye having at least two anionic groups and polyvinyl alcohol-based polymers.

2. The process according to claim 1, wherein each of the anionic groups is any one of a sulfonic acid group, a carboxyl group, a phosphate group, and a base thereof.

3. The process according to claim 1 or claim 2, wherein the organic dye is an azo compound represented by the following general formula (2): 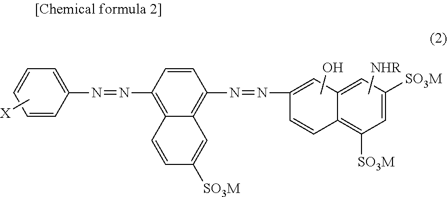
wherein R is a hydrogen atom, an alkyl group having 1 to 3 carbon numbers, an acetyl group, a substituted or unsubstituted benzoyl group, or a substituted or unsubstituted phenyl group;
X is a hydrogen atom, a halogen atom, a nitro group, a cyano group, an alkyl group having 1 to 4 carbon numbers, an alkoxy group having 1 to 4 carbon numbers or a —SO₃M group. M is a hydrogen atom or an alkaline metal atom.

4. The process according to claim 1 or claim 2, wherein a total concentration of the organic amine cations and the multivalent metal cations contained in the water-proof treatment liquid is 10% by weight to 25% by weight relative to the total weight of the water-proof treatment liquid and the tetrahydroxy borate anions have a concentration of 1% by weight to 6% by weight relative to the total weight of the water-proof treatment liquid.

5. The process according to claim 1 or claim 2 wherein the water-proof treatment liquid has a liquid temperature of 5° C. to 60° C.
